(19) United States
(12) Patent Application Publication
(10) Pub. No.: US 2007/0188772 A1
(43) Pub. Date: Aug. 16, 2007

(54) Recursive build job graphical user interface

(75) Inventors: Gary M. Davis, Rochester, NY (US); Marc J. Krolczyk, Spencerport, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/351,823

(22) Filed: Feb. 10, 2006

(51) Int. Cl. G06F 3/12

(52) U.S. Cl. 358/1.1

(57) ABSTRACT

A method for utilizing a graphical user interface for recursive build job programming of multiple job segments requiring different image capture settings or original size into a single production job through a controller for a production system in the form of a multifunction device. The method includes entering and programming each job segment individually on the multifunction device and prompting for a next job segment after each job segment is programmed. A build job progress dialog is provided with the capability for canceling a previous job segment entered, canceling the job, sampling a previous job segment entered, ending the job and printing, and programming the next job segment.

### BACKGROUND AND SUMMARY

This disclosure relates generally to a recursive user interface for a printing device and more particularly to an approach for combining multiple job segments requiring different image capture settings possibly including original size into a single job and providing the capability to assess the progress of the job, delete or reorder job segments, sample individual job segments, or sample the entire job.

In the area of digital printing and copying, there has been a growth in demand for multifunctional electronic printing devices. Such devices may assume the form of an arrangement in which a single print engine (e.g., xerographic or thermal ink jet print engine) is coupled with a plurality of different image input devices (or “services”), with such devices being adapted to produce image related information for use by the printer or transmitted over a network. The image related information, in one example, could have its origin in video facsimile signals, microfilm, data processing information, light scanning platens for full size documents, aperture cards, and microfiche.

When a scanner is employed to generate a job, image bearing documents are scanned so that the images thereon are converted to image data for use in making prints or for transmission over a network. When a network is used to generate the job, a stream of data, including various job related instructions and image data, expressed in terms of a page description language is captured, decomposed, and stored for printing. As is known, a network job can have its origin in a remote client, such as a work station, or a print server with a storage device. Jobs provided at the input section may be stored in a memory section, such as a disk drive.

Multifunctional printing devices are typically full featured, and various ones of the features provide one or more functions to be performed on the job. For example, a job captured at the input image section for storage may undergo a significant amount of image processing allowing for the minimization of image related artifacts and various electronic pages may be edited after the job has been suitably stored. After outputting of the stored job, a host of finishing operations, such as stapling, folding, and trimming may be performed on the hardcopy version of the job to optimize its appearance.

In view of the complexity of a given job, it may be desirable to “build” a job on a segment-by-segment basis. In U.S. Pat. No. 5,081,494 to Reed et al., various parts of a job are merged through use of a job supplement mode. Through this mode, the job supplement function is used to append content to a job as it is being scanned into the printing system. That is, when the job supplement mode is engaged, any number of additional documents or groups of documents may be scanned in with the job currently being scanned. Upon supplementing the job at the scanner, and END JOB icon is selected, and the supplemented job is stored in a memory section of the printing system.

U.S. Pat. No. 5,579,087 to Salgado contemplates the technique of constructing a multi-segment print job from multiple local and remote sources on a network using a network interface to identify print job segments and locations of segments on the network by entering a start build print job function at the network interface, identifying each segment of the print job including segment location, specifying print job characteristics such as quantity and quality for each segment, entering an end build print job function at the network interface, and identifying a printing device on the network, whereby each segment of the print job is accessed and distributed to the printing device to complete the multi-segment print job.

However, these approaches do not permit the user to view current progress, delete or reorder segments, sample individual segments, or sample the entire job. Therefore, what is needed is an iterative dialog for the “build job” feature. Such a dialog would offer the advantages of showing the user's current progress, allowing deletion or reordering of segments, prompting for completion, sampling of individual segments, and sampling of the whole job. For the reasons stated above, and for other reasons stated below which will become apparent to those skilled in the art upon reading and understanding the present specification, there is a need in the art for a graphical user interface providing an iterative dialog for the “build job” feature to enable a user of a multifunctional device to monitor and control the progress of a print job.

All U.S. patents and published U.S. patent applications cited herein are fully incorporated by reference. The following patents or publications are noted:

U.S. Pat. No. 6,151,131 to Pepin et al. (“Print System with Deferred Job Assembly Feature”) describes a method deferred assembly of a job in a document processing system is facilitated with a subsystem for generating electronic representations of respective images from a set of image data in accordance with a set of control instructions. The method includes generating a first electronic representation of a first image at a first time, reading a subset of placemarking instructions, generating a second representation of a second image, and continuing with successive images. However, Pepin provides only a means to defer assembly of a job; he does not provide the capability for showing the user's current progress, allowing deletion or reordering of job segments, sampling of individual segments, or sampling of the entire job.

U.S. Pat. No. 6,215,487 to Barrett et al. (“System for Altering Attribute Values in a Printing System”) teaches a user interface for a multifunctional printing system which enables a user to cause each attribute set in a group of multiple related attribute sets to be altered from a user settable configuration to a default configuration. The user interface provides a first user dialog having a first set of attribute values and a second user dialog having a second set of attribute values, which are selectively displayable on the display screen. The first set of attribute values is alterable from a first user settable configuration to a first default configuration and the second set of attribute values is alterable from a second user settable configuration to a second default configuration. A user activatable area enables a user to alter the attribute values. Barrett et al. is directed to enabling the altering of attribute sets from a user settable configuration to a default configuration but does not provide capability for the deletion or reordering of segments, sampling of individual segments, or reordering of job segments.

U.S. Pat. No. 6,239,880 to Barrett et al. (“Memory Management System for a Printing System”) teaches a user interface associated with an attribute value clearing system in which a user is prompted to delete image data whenever the user seeks to clear attribute values before a data storage threshold has been achieved. Each attribute corresponds with either a default value or a user set value. A set of default values is settable within the user interface, in response to user input, to create a set of user set values. The system also includes a memory for storing at least a part of the image data of the job wherein the stored image data is less than all of the image data of the job. The method includes storing part of the image data in the memory, respectively changing one or more values of the set of user set values to one or more values of the set of default values, and, in response, deleting the part of the image data stored in memory when a selected condition is met. Barrett et al. prompts a user to delete image data whenever the user seeks to clear attribute values before a data storage threshold has been achieved, but does not provide for the deletion or reordering of segments, sampling of individual segments, or reordering of job segments.

U.S. Pat. No. 6,470,155 to Martin et al. (“Multi-market Optimized User Interface Assembly and a Reprographic Machine Having Same”) describes a plural-mode, multi-market user interface assembly and an associated reprographic machine, for increasing user satisfaction and productivity in a plurality of different user markets. The user interface assembly includes a display screen for displaying user dialog information, a series of machine process control and user interactive functional features for operator access to control operation of the machine, and a plurality of different market optimized user dialog information display modes that are connected to the series of machine process control and user interactive functional features. The interface also provides an associated controller and a means or device for selectively switching from one to another of the different market optimized user dialog information display modes. However, Martin et al. does not show the user's current progress, allowing deletion or reordering of segments, prompting for completion, sampling of individual segments, and sampling of the whole job.

The disclosed embodiments provide examples of improved solutions to the problems noted in the above Background discussion and the art cited therein.

There is shown in these examples an improved method for utilizing a graphical user interface in a controller for a multifunction device for recursive build job programming of multiple job segments requiring different image capture settings or original size into a single production job. The method includes entering and programming each job segment individually on the multifunction device and prompting for a next job segment after each job segment is programmed. A build job progress dialog is provided with the capability for canceling a previous job segment entered, canceling the job, sampling a previous job segment entered, ending the job and printing, and programming the next job segment.

In another embodiment there is provided a production system controller having a display in the form of a graphical user interface for providing capability for recursive build job programming of multiple job segments requiring different image capture settings or original size into a single production job. The controller includes capability for entering and programming each job segment individually on the multifunction device and for prompting for a next job segment after each job segment is programmed. The controller, through the graphical user interface, also provides a build job progress dialog with the capability for canceling a previous job segment entered, canceling the job, sampling a previous job segment entered, ending the job and printing, and programming the next job segment.

In yet another embodiment there is provided a computer-readable storage medium having computer readable program code embodied in the medium. When the program code is executed by a computer, the program code causes the computer to perform method steps for recursive build job programming of multiple job segments requiring different image capture settings or original size into a single production job. The method includes entering and programming each job segment individually on the multifunction device and prompting for a next job segment after each job segment is programmed. A build job progress dialog is provided with the capability for canceling a previous job segment entered, canceling the job, sampling a previous job segment entered, ending the job and printing, and programming the next job segment.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a perspective view of a multifunctional printing device;

FIG. 2 is a perspective view of one embodiment of a control panel for a multifunctional printing device;

FIG. 3 is a view of one embodiment of a user interface having build job functionality;

FIG. 4 through FIG. 7 illustrate example embodiments of dynamic graphic displays for implementing a recursive build job user interface;

FIG. 8 is a flow chart illustrating a one embodiment of a method for providing a recursive build job feature through a user interface; and

FIG. 9 illustrates another example embodiment of a dynamic graphic display for implementing a recursive build job user interface.

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The method and system for utilizing a user interface described herein provides improved “build job” design and workflow capability, allowing a user to combine multiple segments of a job (requiring different image capture settings and/or original size) into one job and apply the same finishing or collation to the entire set. The interface provides an optional recursive dialog that appears between segments of a build job, showing the user's current progress, allowing deletion or reordering of job segments, prompting for completion, sampling of individual segments, or sampling of the entire job.

While for the purposes of explanation the user interface will be described as functioning within a document production system to direct finishing operations, it will be appreciated by those skilled in the art that the user interface may be beneficially utilized in any production environment which offers a build job feature for the programming of production printing. All such variations and modifications are fully contemplated by the scope of the specification and claims herein. For the case of a document production system in which the build job feature is offered the user is presented with a feature dialog option. Upon activation of the option, controls are presented for programming each segment. After each segment is programmed, the user is presented with the build job dialog detailing the segments as they have been captured and prompting the user to program the next segment, cancel, or complete the job programming. Additional controls may be provided to sample, delete, or reorder segments.

Various computing environments may incorporate capabilities for supporting document production capabilities utilizing printing system controllers, print submission utilities and finishing equipment on which the recursive build job option user interface may reside. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

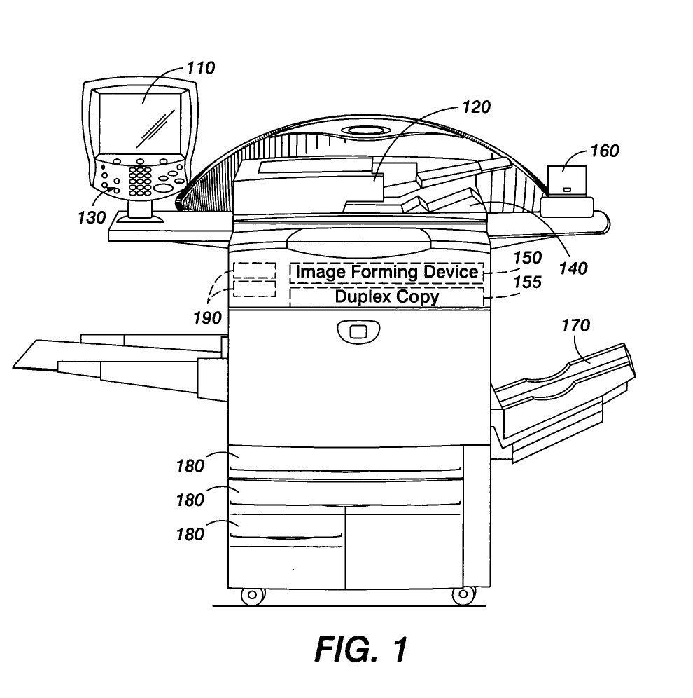

Referring to FIG. 1 of the drawings, a multifunctional digital printing apparatus of the type suitable for use with the user interface includes a document feeder 120, a user interface 110, and a control panel 130. After desired conditions have been entered on the user interface 110, through the aid of control panel 130, document feeder 120 conveys a document to a predetermined reading position on an image reading device 140 and, after the document has been read, drives it away from the reading position. The image reading device 140 illuminates the document brought to the reading position. The resulting reflection from the document is transformed to a corresponding electric signal, or image signal, by a solid state imaging device, e.g., a CCD (Charge Coupled Device) image sensor. An image forming device 150 forms an image represented by the image signal on a plain paper or a thermosensitive paper by an electrophotographic, thermosensitive, heat transfer, ink jet, or similar conventional system.

As a sheet of paper is fed from any one of paper cassettes 180 to the image forming device 150, the device 150 forms an image on one side of the paper. A duplex copy unit is utilized to turn over the paper carrying the image on one side thereof, and again feed it to the image forming device 150. As a result, an image is formed on the other side of the paper to complete a duplex copy. The duplex copy unit 155 has customarily been designed to re-feed the paper immediately or to sequentially reefed a plurality of papers stacked one upon the other, from the bottom sheet of paper to the top sheet of paper. The sheets of paper, or duplex copies, driven out of the image-forming device 150 are sequentially sorted by an output device 170 in order of page or page by page.

Various applications may share the document feeder 120, control panel 130, user interface 110, image reading device 140, image forming device 150, duplex unit, output device 170, and paper cassettes 180, which are the resources included in the multifunction device. The applications may include a copier application, a printer (IOT) application, a facsimile (Fax) application, as well as other applications. Additionally, the digital copier system is coupled with a network by way of conventional network connections.

The system and method herein for utilizing the user interface are not limited to a particular type of network system to which the multifunction device is connected. Typical network interfaces include general-purpose systems such as POTS (plain-old telephone systems) and ISDN (Integrated Services Digital Network), as well as special-purpose systems such as a LAN (local-area network) or a WAN (wide-area network). Such networking environments are commonplace in offices, enterprise-wide computer networks, intranets and the Internet. Those skilled in the art will appreciate that the principles of the system and method described herein can be applied to virtually any network system without departing from the scope of the claims and specification.

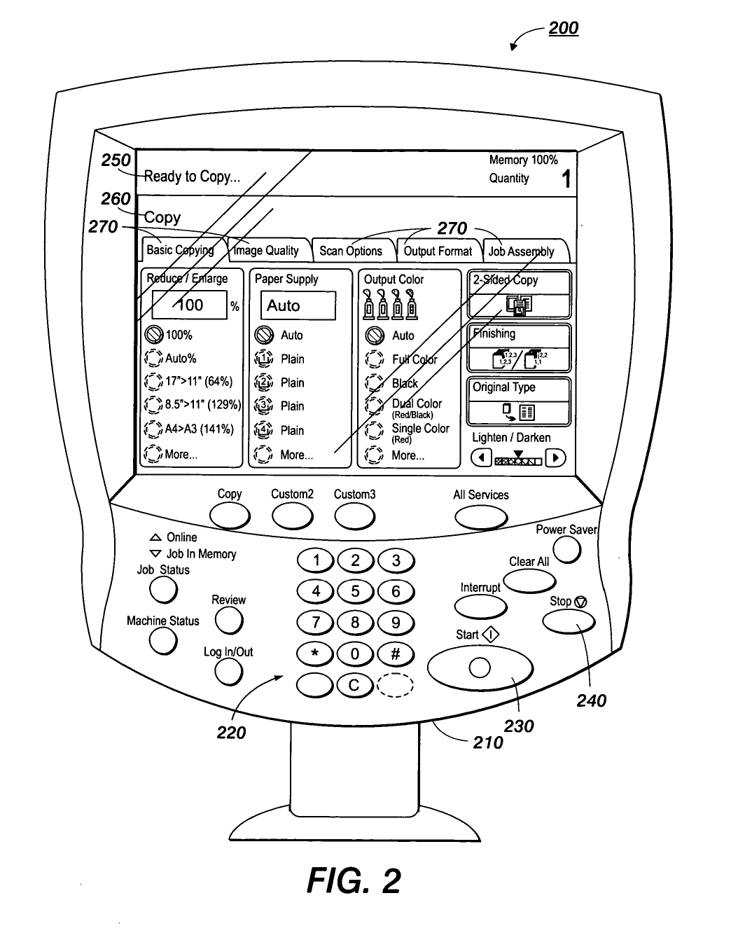

Turning now to FIG. 2, an example embodiment of the user interface is illustrated. Users can access the graphical user interface by any known means, for example through a panel and screen on the body of the multifunction device or through a monitor connected to the multifunction device. The interface includes an output device, such as a display device, input devices, such as a keyboard, touch-screen, mouse, or pointer, and communication circuitry. The output device, for example a monitor, displays information for viewing by a user of the multifunction device and the input device is used to control a screen pointer provided by the graphical user interface of the operating system. For the purposes of discussion herein the output device and input device are shown in the form of a monitor 200. Monitor 200 includes input device (control panel) 210 and output device (display screen) 250. Control panel 210 typically includes keypad 220, start button 230, and stop button 240. As will be appreciated by those experienced in the art, other input devices, such as a touch sensitive video screen, keyboard, joystick, mouse-based pointer, or other point and click devices may be utilized, all of which are contemplated by the specification and scope of the claims herein. Various other optional features may be included, such as Power Saver, Job Status, Machine Status, Review, and Customization buttons, etc.

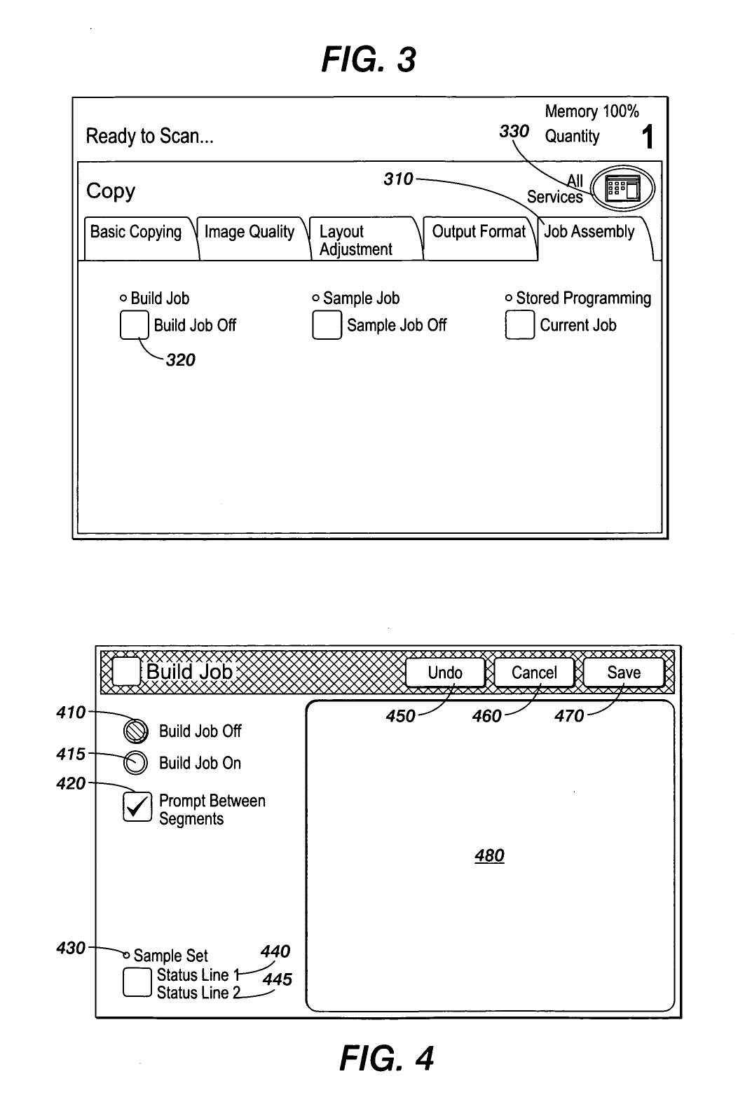

Display screen 250 presents the user interface, in this illustration showing a copy screen 260. The interface includes various functionality tabs 270, including basic copying, image quality, scan options, output format, and job assembly. For this example embodiment tabs are selected through a touch screen, but a mouse, adjacent control panel buttons, keyboard-commands or touch-pad and stylus may be utilized. The features of this display will be discussed more fully herein below with respect to FIGS. 3-7.

Turning now to FIG. 3, there is illustrated one embodiment of the method for the recursive build job feature on a user interface. The user of a device communicating with a print system selects job assembly tab 310 on the user interface of the device, which may be accomplished through a touch pad, touch screen, buttons, selection of an icon, or a keypad. The user interface then displays a listing of job assembly options, such as build job, sample job, and stored programming. The job assembly options may be accompanied by window-bearingbuttons, such as build job window-bearingbutton 320, which includes an on/off default indicator. A dynamic label may be present displaying the status options “off” or “on”. In the example illustrated in FIG. 3, the dynamic label displays the phrase “Build Job Off”. While the build job option is activated, the dynamic label changes to “Build Job On”. By selecting the build job window-bearing button, the build job user interface is activated. Optionally, a second dynamic label may be present, displaying “(N) Segments”, with N being the number of job segments in the print job. An all services button 330 may also be provided, which, when selected, presents a confirmation dialog asking the user if they wish to cancel the build job and exit the service. For example, the interface presents a window that is titled “Build job is in progress” followed by the inquiry “Delete this job and exit this service?” and buttons for “yes” or “No”.

Turning now to FIG. 4, when the build job option is entered (“Build Job On”), the interface presents an initial build job window. Option buttons 410 and 415 indicate whether the build job feature is on or off. Upon initial entry, the build job off button 410 is selected as a default and the prompt between segments box is checked. The initial feature window also includes settings window command buttons 450, 460, and 470. Undo command button 450 permits a user to reset the screen back to the settings that were present when the user opened the dialog. When the Save button 470 is selected, the Build Job selection will be saved and the window will be closed.

When the Cancel button 460 is selected, the Build Job selection will be canceled and the window will be closed. Content well 480 may include textual material relating to the operation of the Build Job feature, for example, the following language may appear in content well 480: “Build Job allows assorted sets of originals, each with different settings, to be combined into one job. This feature is especially useful for jobs scanned on the Document Glass. After you build a job by scanning each set of originals, the individual segments are printed as a single job.” A sample set window-bearing button 430 may optionally be displayed, accompanied by one or more status lines 440 and 445 which indicate “On” or “Off”.

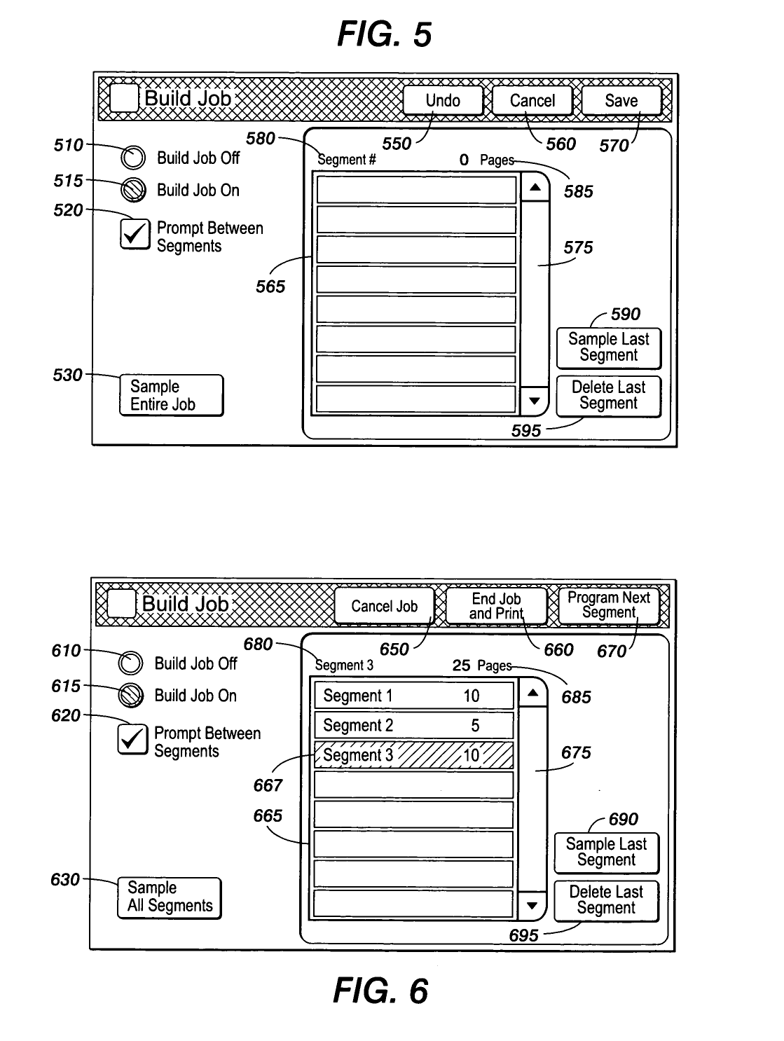

FIG. 5 illustrates the window presented by the interface with the initial selection of the “Build Job On” feature 515. “Build Job Off” feature 510 is inactivated, while the “Prompt Between Segments” default check box 520 remains active. The Build Job Settings window is automatically displayed at the start-button press of each job segment capture if this box is checked. For example, if a print job contains three segments, after the start button is pressed to begin the scan of each segment, this window will be displayed. Alternatively, this window may not be displayed until the segment is finished scanning. If this box is not checked, the Build Job Settings window will not be displayed automatically but will be displayed when the Build Job window-bearing button is selected. Scrollable table 565 includes two column headers “Segment” 580 and “N Pages” 585 for the print job. “N” is a dynamic label that reflects the total pages captured in all segments of a print job. Since in this view no segments have been listed, “0” pages appears for 585. When the “Build Job On” option is initially selected, the window displays an empty table and disabled command buttons 550, 560, and 570. The user can scroll to display additional segments if present through use of scroll bar 575.

This window may also include “Sample Last Segment” button 590 and “Delete Last Segment” button 595, which are provided for marking services but not for scanning or faxing and both of which are disabled until job segments are captured. The window may also include a button 530 labeled “Sample Entire Job” or “Sample All Segments” which, when activated, will cause all segments to be printed as captured with the finishing options as set and a quantity of one.

Whenever a Sample of any or all segments is being processed, the Start hard button 230 on the control panel shown in FIG. 2 is inhibited. If Start is pressed while a Sample of all segments is being processed, a conflict tone may sound, and a message may be displayed telling the user to wait while the sample is being processed. Similarly, whenever a Sample of all segments is being processed, the “Sample Last Segment” button 590 and “Delete Last Segment” button 595 will be disabled. If either button is selected while a Sample is being processed, a conflict tone may sound and a message may be displayed telling the user to wait while the sample is being processed.

Referring now to FIG. 6, the illustration shows the Build Job On Child Window displayed between job segment captures if the prompt window 620 is checked or the Build Job window-bearing button is selected after segments have been captured. At the start of scanning, a row is added to table 665 as the selected row, highlighted in this example as entry 667. The row will contain “Segment n” and “x”, (with n referring to the ordinal number of the segment and x referring to the dynamic count of the number of images in the job segment). After Start is pressed on the control panel and before the job segment is completed, a message appears in the status message area telling the user that scanning of the build job segment is in process.

After a job segment has been captured and the build job Settings window is automatically displayed (for cases in which the Prompt Between Segments box is checked) or the Build Job window-bearing button was selected, the command buttons at the top of the settings window change to “Cancel Job” 650, “End Job and Print” (or “End Job and Send” for non-marking services) 660 and “Program Next Segment” 670. The last captured segment is added to the table and is automatically selected. Additionally, the table command buttons (“Sample Last Segment” 690 and “Delete Last Segment” 695 are disabled while a segment is being captured. As discussed above, Build Job Off button 610 is inactive, with Build Job On button 615 active. After Build Job is started, the On and Off buttons 615 and 610 become disabled with the On button 615 retaining the selected but disabled state. While in a build job mode, the interface prompts the user to scan the next segment. Sample language for this prompt may include

“Ready to scan your next segment.”

Selecting the disabled build job on or off buttons 615 or 610 may sound a conflict tone and present a brief message, such as

“Build job is already in progress. Press Start to scan next segment or Cancel.”

This window also includes “Sample Last Segment” button 690 and “Delete Last Segment” button 695, both of which are enabled when job segments are captured. “Sample Last Segment” button 690 enables a user to print the last segment programmed in the job set. When sampling a segment the user may be notified with an alert tone and/or a brief advisory message, such as

“The output may not represent the final document until all segments are captured.”

During a sample segment, the Start hard button 230 on the control panel shown in FIG. 2 is inhibited. Pressing the Start button while a sample is in progress may sound a conflict tone and/or present a brief message such as

“Please wait until the current segment finishes printing.”

Whenever Sample Last Segment 690 or Delete Last Segment 695 is being processed, both buttons are disabled. If the Sample Last Segment button 690 is selected while disabled, a conflict tone may sound and/or a message such as

“A segment is not ready to be sampled”

may be displayed. Whenever a Sample is being processed, a message similar to the following will be displayed for the entire time the sample is being processed:

“Printing sample of last segment.”

When the sample processing is complete, the original “Ready to Scan your Build Job Segment” message is again displayed. “Delete Last Segment” button 695 deletes the last input segment and removes the segment row from the segment table. The page tally is updated in the table row header and the previous segment in the list is automatically selected. When a segment is deleted, an alert tone may sound and/or the user may be informed via a brief message approximately as follows:

“The last segment was deleted.”

After deleting the last segment, the “Delete Last Segment” and “Sample Last Segment” buttons, 695 and 690 respectively, will become disabled until a new segment is scanned. If the “Delete Last Segment” button 695 is selected and disabled (if no segments are being processed), a conflict tone may sound and the user may be informed via a brief message such as

“A segment is not ready to be deleted.”

The window may also include a button 630 labeled “Sample Entire Job” or “Sample All Segments” which, when activated, will cause all segments to be printed as captured with the finishing options as set and a quantity of one.

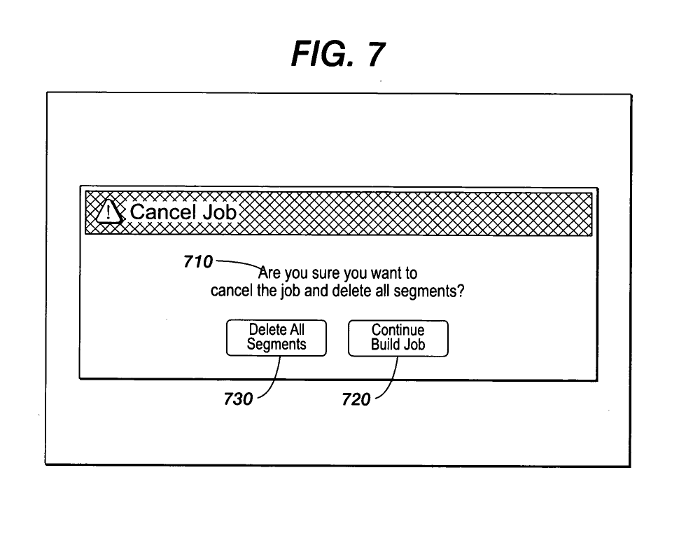

Selecting “Program Next Segment” button 670 closes the Build Job window and returns the user to the programming screen that was open before the Build Job window opened. (Program Next Segment) is selected when programming or review of one segment is completed and another segment is to be programmed. The “End Job and Print” button 660 is utilized when programming of all segments of a job have been completed and the job is to be printed. In the case of non-marking services (e.g., scan and fax) button 660 will display as “End Job and Send”. When Build Job is on and the user selects the “End Job and Print” or “End Job and Send” button 660, the system exits Build Job's “image collection” mode and submits the job to the marking engine. The selection of quantity and output options can be made at any time before the “End Job and Print” button is selected. These selections will apply to the entire job and cannot be set independently for an individual segment. End Job and Print can be selected during the scanning of the last segment. If this is done, then the job will be considered complete and the entire job will begin processing as soon as possible. Selecting “End Job and Print” or “End Job and Send” 660 will also close the Build Job window and turn the Build Job feature off. Cancel Job button 650 enables deletion of an entire job with all its segments. When Cancel Job button 650 is selected, a confirmation dialog illustrated in FIG. 7 is presented.

Turning now to FIG. 7, the cancel job dialog includes message 710, which inquires whether the user wants to cancel the job and delete all segments. To confirm job cancellation, the user activates “Delete All Segments” button 730. Confirming a cancel will delete all segments and may sound an alert tone and/or display a confirming message such as

“All segments of the job have been deleted.”

If the user elects not to proceed with cancellation of the job, button 720, “Continue Build Job” is selected.

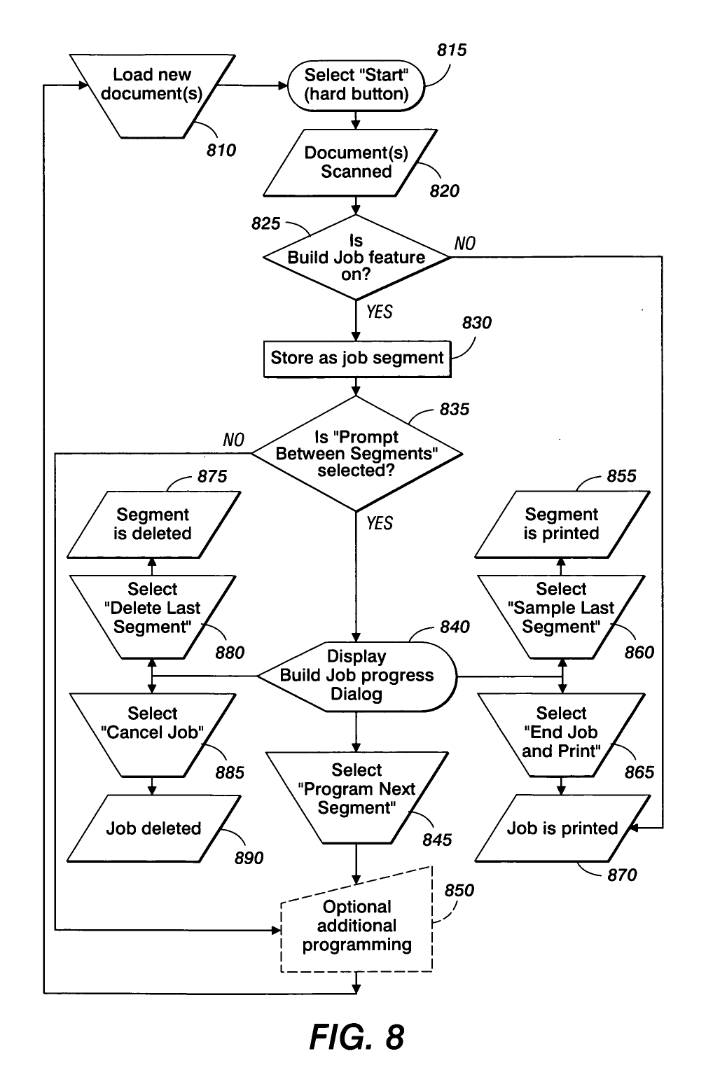

Turning now to FIG. 8, the flowchart illustrates the method for use of a recursive user interface with a multifunction printing device to combine multiple job segments requiring different image capture settings or original size into a single job and providing the capability to assess the progress of the job, delete or reorder job segments, sample individual job segments, or sample the entire job. After new documents for a job segment have been loaded on the multifunction device at 810, the user selects the “Start” hard button on the control panel of the multifunction device at 815. The multifunction device scans the new documents at 820 and a determination is made as to whether the Build Job feature has been selected at 825. If the Build Job feature has not been selected, the job is printed at 870.

If the Build Job feature has been selected at 825, the document(s) are stored as a job segment at 830. The system then determines whether the “Prompt Between Segments” feature has been selected at 835. If the “Prompt Between Segments” feature has not been selected, optional additional programming may be performed at 850 before new document(s) are again loaded at 810 and the user again presses the “Start” hard button on the device control panel at 815. If the “Prompt Between Segments” feature has been selected, a Build Job progress dialog is displayed at 840, presenting the user with various options for handling the job segment. If the user selects “Delete Last Segment” capability 880, the current job segment is deleted at 875. If the user selects the “Cancel Job” option at 885, the entire print job with all its segments is deleted at 890. The Build Job progress dialog also presents the user with the option of “Sample Last Segment” at 860. If this option is selected, the current job segment is printed at 855. The user may also select “End Job and Print” at 865, in which case the entire print job with all its segments is printed at 870.

Alternatively, the user may select the “Program Next Segment” option at 845. The user may then perform additional programming on the job segment at 850 or load new document(s) for the next job segment at 810. As each new job segment is loaded and scanned by the scanner of the multifunction device and the start button is pressed, the user is prompted through the Build Job features and the Build Job progress dialog 840 is displayed to enable the user to assess the progress of the job, delete or reorder job segments, sample individual job segments, or sample the entire job.

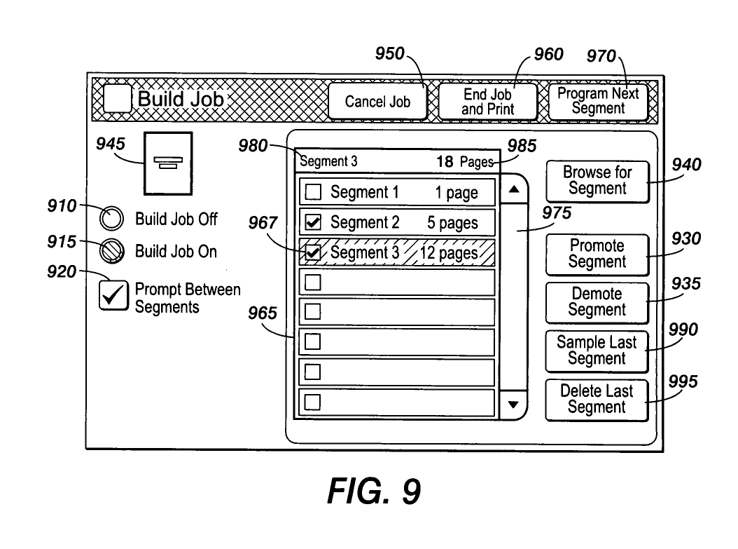

Referring now to FIG. 9, the illustration shows optional features that may be made available through the Build Job On Child Window displayed between job segment captures. At the start of scanning, a row is added to multi-selection table 965 as the selected row, highlighted in this example. The row will contain a selectable check box, “Segment n” and “x”, (with n referring to the ordinal number of the segment and x referring to the dynamic count of the number of images in the job segment). After Start is pressed on the control panel and before the job segment is completed, a message appears in the status message area telling the user that scanning of the build job segment is in process.

After a job segment has been captured and the build job Settings window is automatically displayed (for cases in which the Prompt Between Segments box is checked) or the Build Job window-bearing button was selected, the command buttons at the top of the settings window change to “Cancel Job” 950, “End Job and Print” (or “End Job and Send” for non-marking services) 960 and “Program Next Segment” 970. The last captured segment is added to the table and automatically selected. The functionality for these features is discussed above for items 650, 660, and 670 in FIG. 6.

As discussed above, Build Job Off button 910 is inactive, with Build Job On button 915 active. After Build Job is started, the On and Off buttons 915 and 910 become disabled with the On button 915 retaining the selected but disabled state. While in a build job mode, the interface prompts the user to scan the next segment. Sample language for this prompt may include

“Ready to scan your next segment.”

Selecting the disabled build job on or off buttons 915 or 910 may sound a conflict tone and present a brief message, such as

“Build job is already in progress. Press Start to scan next segment or Cancel.”

This window also includes “Sample Segment” button 990 and “Delete Segment” button 995, both of which are enabled when job segments are captured. “Sample Segment” button 990 enables a user to print one or more segments selected from table 965. When sampling a segment the user may be notified with an alert tone and/or a brief advisory message, such as

“The output may not represent the final document until all segments are captured.”

During a sample segment, the Start hard button 230 on the control panel shown in FIG. 2 is inhibited. Pressing the Start button while a sample is in progress may sound a conflict tone and/or present a brief message such as

“Please wait until the current segment finishes printing.”

Whenever Sample Segment 990 or Delete Segment 995 is being processed, both buttons are disabled. If the Sample Segment button 990 is selected while disabled, a conflict tone may sound and/or a message such as

“A segment is not ready to be sampled”

may be displayed. Whenever a Sample is being processed, a message similar to the following will be displayed for the entire time the sample is being processed:

“Printing sample of segment(s).”

When the sample processing is complete, the original “Ready to Scan your Build Job Segment” message is again displayed. “Sample Segment” button 990 also enables a user to print a sample of the entire job, after the checkbox beside each and every job segment listed in multi-selection table is checked. Alternatively, the window may include a “Sample All Segments” button (not shown in this figure) to print a sample of the entire job. The system then composes a master of all of the segments which have been captured to that point and submits them to the job queue with a quantity of “1”. The Sample will be promoted automatically to print as soon as possible without interrupting the currently marking job, regardless on a contention management strategy. When the Sample processing is complete, the original “Ready to Scan your Build Job segment” message is again displayed. Whenever a Sample of all segments is being processed, the Start hard button 230 on the control panel shown in FIG. 2 is inhibited.

If Start is pressed while a Sample of all segments is being processed, a conflict tone may sound, and a message may be displayed telling the user to wait while the sample is being processed. Similarly, whenever a Sample of all segments is being processed, the “Sample Segment” button 990 and “Delete Segment” button 995 will be disabled. If either button is selected while a Sample is being processed, a conflict tone may sound and a message may be displayed telling the user to wait while the sample is being processed.

“Delete Segment” button 695 deletes segments identified by checkboxes from the multi-selection table and removes the segment row from the multi-selection table. The page tally is updated in the table row header 980 and the previous segment in the list is automatically selected. When a segment is deleted, an alert tone may sound and/or the user may be informed via a brief message approximately as follows:

“The segment was deleted.”

If all segments have been deleted, the “Delete Segment” and “Sample Segment” buttons, 995 and 990 respectively, will become disabled until a new segment is scanned. If the “Delete Segment” button 995 is selected and disabled (if no segments are being processed), a conflict tone may sound and the user may be informed via a brief message such as

“A segment is not ready to be deleted.”

Selecting “Promote Segment” button 930 enables the operator to promote one or more selected segment(s) up the table by one position, reflected in the revised table. “Demote Segment” button 935 provides the capability to demote one or more selected segment(s) down the table by one position, reflected in the revised table. Selecting the “Browse for Segment” button 940 enables a user to search for a captured segment in a local or networked repository and add that segment to the existing build job. While the method has been described with reference to a user interface having buttons, a touch screen, or icons to make selections and perform operations, it will be appreciated by one skilled in the art that the method may be practiced by a series of screen prompts through the user interface, which is fully contemplated by the specification and scope of the claims herein. Also, while for the purposes of this disclosure, build job functionality was described with reference to printing systems, it is noted that it may be utilized in copier applications, printer (IOT) applications, facsimile (Fax) applications, and scan to email, as well as other applications.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device that stores, processes, routes, manipulates, or performs like operations on data. It is to be understood, therefore, that this disclosure is not limited to the particular forms illustrated and that it is intended in the appended claims to embrace all alternatives, modifications, and variations that do not depart from the spirit and scope of the embodiments described herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. In a controller for a production system in the form of a multifunction device, wherein the controller includes a display in the form of a graphical user interface, a method for recursive build job programming of multiple job segments requiring different image capture settings or original size into a single production job, the method comprising:
entering and programming each job segment individually on the multifunction device;
prompting for a next job segment after each job segment is programmed; and
providing a build job progress dialog with the capability for canceling a previous job segment entered, canceling the job, sampling a previous job segment entered, ending the job and printing, and programming the next job segment.

2. The method for recursive build job programming utilizing a graphical user interface according to claim 1, wherein canceling said previous job segment comprises deleting said previous job segment.

3. The method for recursive build job programming utilizing a graphical user interface according to claim 1, wherein canceling the job comprises deleting an entire job with all of its job segments.

4. The method for recursive build job programming utilizing a graphical user interface according to claim 1, wherein sampling said previous job segment comprises printing said previous job segment.

5. The method for recursive build job programming utilizing a graphical user interface according to claim 1, wherein ending the job and printing comprises printing the entire job.

6. The method for recursive build job programming utilizing a graphical user interface according to claim 1, further comprising sampling a job.

7. The method for recursive build job programming utilizing a graphical user interface according to claim 6, wherein sampling a job comprises:
composing a master of all job segments already captured and programmed; and
submitting said master to the job queue with a quantity of “one”.

8. The method for recursive build job programming utilizing a graphical user interface according to claim 1, wherein providing a build job progress dialog further comprises presenting a scrollable table wherein is listed each job segment as it is entered.

9. The method for recursive build job programming utilizing a graphical user interface according to claim 8, wherein said scrollable table further includes the number of pages included in each said listed job segment.

10. The method for recursive build job programming utilizing a graphical user interface according to claim 1, wherein providing a build job progress dialog further comprises presenting the total number of job segments entered.

11. The method for recursive build job programming utilizing a graphical user interface according to claim 1, wherein providing a build job progress dialog further comprises presenting the total number of pages for all job segments entered for the job.

12. The method for recursive build job programming utilizing a graphical user interface according to claim 1, wherein canceling the job further comprises presenting a cancel job dialog requesting confirmation that said job with all its segments is to be deleted.

13. The method for recursive build job programming utilizing a graphical user interface according to claim 8, further comprising providing means for selection of individual job segments listed in said scrollable table.

14. The method for recursive build job programming utilizing a graphical user interface according to claim 1, wherein said build job progress dialog further provides the capability for browsing for at least one pre-existing job segment.

15. The method for recursive build job programming utilizing a graphical user interface according to claim 14, wherein browsing for at least one job segment enables searching for a captured job segment in a local or networked repository and adding said captured job segment to an existing build job.

16. The method for recursive build job programming utilizing a graphical user interface according to claim 8, wherein said build job progress dialog further provides the capability for promoting at least one job segment from a first position in said scrollable table to a second position in said scrollable table.

17. The method for recursive build job programming utilizing a graphical user interface according to claim 8, wherein said build job progress dialog further provides the capability for demoting at least one job segment from a first position in said scrollable table to a second position in said scrollable table.

18. The method for recursive build job programming utilizing a graphical user interface according to claim 1, wherein said method may be practiced by at least one member selected from the group consisting of printer, copier, facsimile, and scan to email applications.

19. The method for recursive build job programming utilizing a graphical user interface according to claim 1, wherein said build job progress dialog further provides the operator with advisory messages when selected operations are in process.

20. A controller for a production system, wherein the controller includes a display in the form of a graphical user interface providing capability for recursive build job programming of multiple job segments requiring different image capture settings or original size into a single production job, the controller comprising:
means for entering and programming each job segment individually on the multifunction device;
means for prompting for a next job segment after each job segment is programmed; and
means for providing a build job progress dialog with the capability for canceling a previous job segment entered, canceling the job, sampling a previous job segment entered, ending the job and printing, and programming the next job segment.

21. A computer-readable storage medium having computer readable program code embodied in said medium which, when said program code is executed by a computer causes said computer to perform method steps for concurrent programming of multiple feature operations to a single production job, the method comprising:
entering and programming each job segment individually on the multifunction device;
prompting for a next job segment after each job segment is programmed; and
providing a build job progress dialog with the capability for canceling a previous job segment entered, canceling the job, sampling a previous job segment entered, ending the job and printing, and programming the next job segment.
